(19) United States
(12) Patent Application Publication
(10) Pub. No.: US 2005/0289289 A1
(43) Pub. Date: Dec. 29, 2005

(54) Software to erase a non-volatile storage device

(76) Inventor: Albert H. Chang, Houston, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/875,600

(22) Filed: Jun. 24, 2004

(51) Int. Cl. G06F 12/00; G06F 9/00

(52) U.S. Cl. 711/103; 713/2; 711/159

(57) ABSTRACT

In accordance with at least some embodiments of the invention, a system comprises a processor, a non-volatile storage device coupled to the processor, a read-only memory (ROM) coupled to the processor and to the non-volatile storage device, and software stored in the ROM. The software is executable by the processor and configured to erase the non-volatile storage device by overwriting substantially all of the addressable locations of the non-volatile storage device while boot firmware is controlling the system.

### BACKGROUND

Computer systems may comprise multiple storage devices, some of which may be non-volatile storage devices, such as hard disk drives. The non-volatile storage devices may store sensitive information, such as an organization's confidential communications. When sensitive data on a non-volatile storage device is no longer needed, the storage device may be erased. In some computer systems, erasing data off of a storage device refers to marking the data as “deleted.” As such, the storage space associated with the “deleted” data is made available for reuse, but the deleted data remains on the device until overwritten. Securely and permanently erasing a non-volatile storage device may require software that permanently removes all of the data stored on the device. Unfortunately, such software may need to be loaded onto the computer system through a bootable media, such as a bootable CD-ROM. In addition, the developer of the software may be an untrusted third-party, thereby introducing uncertainty over the effectiveness of the removal procedure.

### BRIEF SUMMARY

At least some of these issues are addressed by a computer-implemented method and system for erasing a non-volatile storage device. In some embodiments, the system comprises a processor, a non-volatile storage device coupled to the processor, a read-only memory (ROM) coupled to the processor and to the non-volatile storage device, and software stored in the ROM. The software is executable by the processor and configured to erase the non-volatile storage device by overwriting substantially all of the addressable locations of the non-volatile storage device while boot firmware is controlling the system.

### BRIEF DESCRIPTION OF THE DRAWINGS

For a detailed description of exemplary embodiments of the invention, reference will now be made to the accompanying drawings in which:

FIG. 1 shows a system configured in accordance with embodiments of the invention;

FIG. 2A shows at least some of the contents of the read-only memory of FIG. 1 in accordance with embodiments of the invention;

FIG. 2B shows at least some of the contents of the read-only memory of FIG. 1 in accordance with alternative embodiments of the invention;

FIG. 2C shows the contents of the memory of FIG. 1 in accordance with at least some embodiments of the invention;

FIG. 3 shows a procedure for erasing a non-volatile storage divine in accordance with embodiments of the invention; and

FIG. 4 shows the interaction between the components of FIG. 1 during an exemplary data removal procedure.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . . ” Also, the term “couple” or “couples” is intended to mean either an indirect or direct electrical connection. Thus, if a first device couples to a second device, that connection may be through a direct electrical connection, or through an indirect electrical connection via other devices and connections.

In addition, the term “read-only memory” (ROM) is intended to encompass all types of read-only memory, such as programmable read-only memory (PROM), erasable programmable read-only memory (EPROM), electronically erasable read-only memory (EEPROM), and flash EEPROM.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

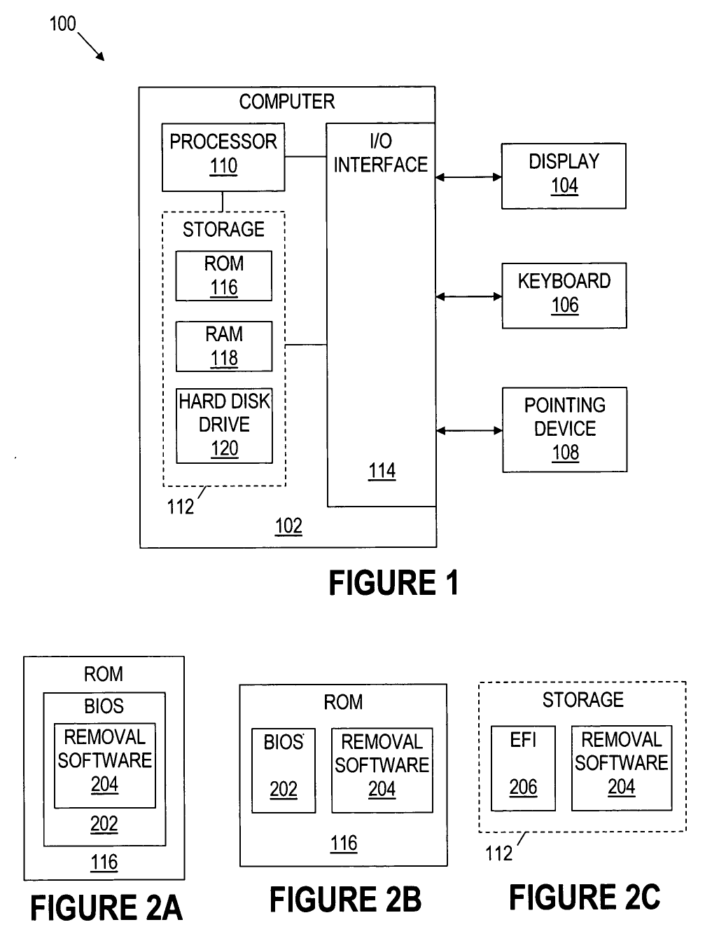

FIG. 1 shows a system configured in accordance with embodiments of the invention. As shown, the system 100 comprises a computer 102 coupled to one or more input/output (I/O) devices, such as a display 104, a keyboard 106, and a pointing device 108. The computer 102 comprises a processor 110, one or more storage devices 112 (referred to as “storage”), and an I/O interface 114. The I/O interface 114 may facilitate the exchange of data between the I/O devices 104-108 and the computer 102. The storage 112 may comprise any type of volatile or non-volatile memory, such as read-only memory (ROM) 116, random access memory (RAM) 118, and a hard disk drive 120. Although not specifically shown, the storage 112 may store an operating system (OS), such as Microsoft® Windows, UNIX, and Solaris, that is executed by the processor 110. The operating system provides a user with an interface to the system 100. Other hardware devices, such as memory controllers, graphics accelerators, and network interfaces, may be included as desired. The system 100 may be representative of or adapted to a desktop, a laptop, a server, or any other type of computer system.

FIG. 2A shows at least some of the contents of the ROM 116 in accordance with at least one embodiment of the invention. The ROM 116 comprises a basic input output system (BIOS) 202. The BIOS 202 may comprise a basic set of software routines that are used to boot the system 100. The software routines may be responsible for initializing hardware components and performing self-diagnostics, such as the power-on self test (POST). The software routines also may be capable of directly accessing the hardware components of the system 100, such as the hard disk drive 120, the display 104, and the keyboard 106.

The BIOS 202 also contains executable code 204 that comprises removal software 204. When executed by the processor 110, the removal software 204 is capable of erasing a non-volatile storage device, such as the hard disk drive 120. The removal software 204 erases the non-volatile storage device by overwriting all or substantially all of the addressable locations of the device. For example, in some embodiments the removal software 204 may overwrite 95% or more of the non-volatile storage device. By overwriting the addressable locations, the probability of retrieving the original data is reduced. The removal software 204 may be written in a low-level programming language, such as assembly, or any other suitable programming language. The removal software 204 is integrated with, and acts as a part of, the BIOS 202. Thus, any privileges granted to the BIOS 202, such as direct access to hardware components, are also granted to the removal software 204. The removal software may utilize the software routines of the BIOS 202, or native routines provided as part of the removal software 204, to erase a non-volatile storage device.

FIG. 2B shows an alternative configuration of the ROM 116. In this alternative embodiment, the BIOS 202 and the removal software 204 are distinct ROM-resident software applications.

FIG. 2C shows the storage 112 in accordance with at least some embodiments of the invention. The storage 112 comprises an Extensible Firmware Interface (EFI) 206 and the removal software 204. The EFI 206 provides an interface between operating systems and platform firmware. The interface comprises data tables that contain platform-related information and boot and runtime service calls that are available to the operating system and the loader of the operating system. Like the BIOS 202, the EFI 206 provides a standard environment for booting an operating system and running pre-boot applications. As such, the removal software 204 may be configured to be a pre-boot EFI application, utilizing EFI methods to erase a non-volatile storage device. The methods may be written in any programming language, such as C or assembly, supported by the EFI specification. The removal software 204 and the EFI 206 may be stored in the ROM 116, the hard drive 120, or any other type of storage supported by the EFI 206.

In all configurations (e.g., FIGS. 2A, 2B, and 2C), the removal software 204 is executed by the processor 110 while the boot firmware has control of the system. In FIGS. 2A and 2B the boot firmware is the BIOS 202, while in FIG. 2C the boot firmware is the EFI 206. Thus, the removal software 204 may be a permanent component of a manufactured computer system, integrated with the boot firmware.

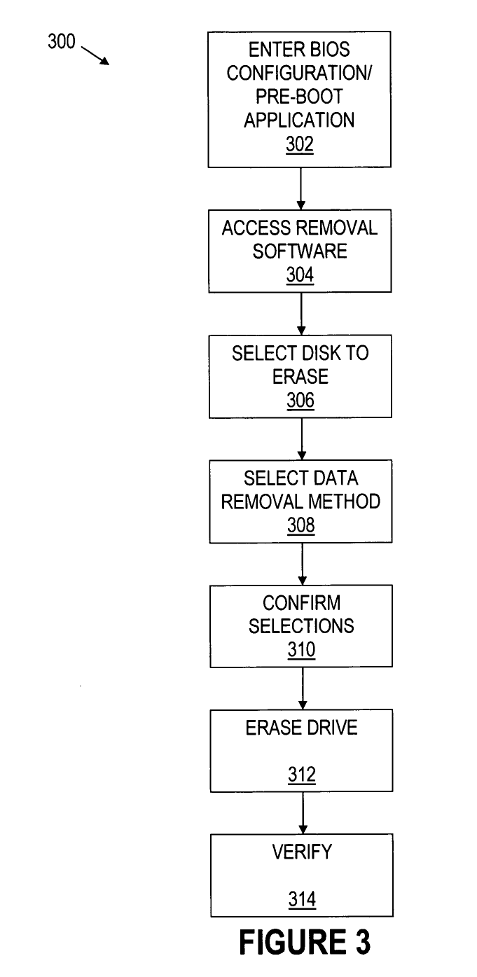

FIG. 3 shows an exemplary procedure 300 for erasing a non-volatile storage device in accordance with various embodiments of the invention. The procedure 300 may begin with a user entering the BIOS configuration, or a suitable pre-boot EFI application by way of the keyboard 106 (block 302). Via a graphical user interface (GUI) displayed on the display 104, the user may access the removal software (block 304) and select which non-volatile storage device to erase (block 306). After selecting the desired storage device, the user may select a data removal method (block 308). The various data removal methods supported by the removal software 204 are discussed below. The user may confirm the selections (block 310), and the removal software 204 may erase the device according to the selections (block 312). After completion, the removal software 204 may verify that the device was erased by the selected removal method (block 314).

The removal software 204 erases a non-volatile storage device in accordance with at least two removal methods. The first removal method may “clear” the selected device by overwriting all addressable locations with a single arbitrary character. The second removal method may “sanitize” the selected device by overwriting all addressable locations on the drive with a character, the complement of the character, and then a random character. The second method may also verify that the sanitation completed successfully. The first and second removal methods are compliant with the Department of Defense (DoD) 5220.22-M standard, entitled “National Industrial Security Manual Operating Manual,” and incorporated herein by reference. As such, the terms “clear” and “sanitize” encompass the corresponding procedures and definitions as defined in the 5220.22-M standard and explained above.

Depending upon the non-volatile storage device selected to be erased (block 306), the computer system may or may not be able to properly boot. If the selected storage device contains critical operating system files, such as those stored in the boot partition, the computer system may not boot properly if the device is erased. As such, the removal software 204 may detect if the selected storage device contains operating system critical files. If the storage device does, the removal software 204 may prompt the user with a warming message of the possible impacts of the removal procedure.

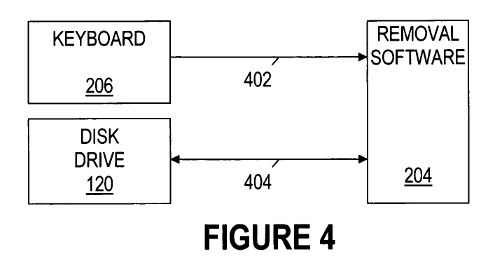

FIG. 4 shows the interaction between components of system 100 during an exemplary removal procedure that erases the data on the disk drive 120. A user may utilize the keyboard 206 to enter the BIOS configuration, or a suitable EFI pre-boot application, and select the desired removal method for the disk drive 120. A request 402 containing the selection may be sent to the removal software 204. Upon receiving the request 402, the removal software 204 may access the disk drive 120 through the appropriate BIOS or EFI routines 404 and perform the selected removal method on the disk drive 120. If an error occurs during the removal process, an appropriate error message may be displayed to the user on the display 104. Although the user in an exemplary removal procedure may utilize the keyboard 206 to select the removal method for the disk drive 120, any other type of I/O device, such as the pointing device 108, may also be used.

Embodiments of the invention provide an efficient mechanism to securely erase a non-volatile storage device. No additional third-party software is needed, although such can be used as desired, and the non-volatile storage device is erased while the boot firmware, such as the BIOS or EFI, has control of the computer system. The removal methods may be fully compliant with the DoD 5220.22-M standard, and the removal software may be integrated with the boot firmware, being a permanent part of a manufactured computer system.

The above discussion is meant to be illustrative of the principles and various embodiments of the present invention. Numerous variations and modifications will become apparent to those skilled in the art once the above disclosure is fully appreciated. For example, the removal software may erase one or more or all of a plurality of non-volatile storage devices. The removal software may function in a batch mode to erase the selected devices. It is intended that the following claims be interpreted to embrace all such variations and modifications.

1. A computer system, comprising:
a processor;
a non-volatile storage device coupled to said processor;
a read-only memory (ROM) coupled to said processor and to said non-volatile storage device; and
software stored in said ROM, wherein said software is executable by the processor and configured to erase the non-volatile storage device by overwriting substantially all of the addressable locations of the non-volatile storage device while boot firmware is controlling the system.

2. The computer system of claim 1 wherein said ROM is selected from the group consisting of programmable read-only memory (PROM), erasable programmable read-only memory (EPROM), electronically erasable read-only memory (EEPROM), and flash EEPROM.

3. The computer system of claim 1 wherein said boot firmware is a basic input output system (BIOS) and said software is integrated with the BIOS.

4. The computer system of claim 1 wherein said boot firmware is an Extensible Firmware Interface (EFI) that is adapted to initialize and boot the system.

5. The computer system of claim 4 wherein said software is integrated with the EFI.

6. The computer system of claim 1 wherein said software is configured to clear said non-volatile storage device by writing a character to all addressable locations of said non-volatile storage device.

7. The computer system of claim 1 wherein said software is configured to sanitize said non-volatile storage device by writing a character, the complement of said character, and a random character to all addressable locations of said non-volatile storage device.

8. A computer system, comprising:
a processor;
a non-volatile storage device coupled to said processor;
a first and second memory coupled to said processor and to said non-volatile storage device; and
software stored in said first memory and boot firmware stored in said second memory, wherein said software is executable by the processor and configured to overwrite substantially all of the addressable locations of the non-volatile storage device while said boot firmware is initializing the system.

9. The computer system of claim 8 wherein said software is configured to overwrite all of the addressable locations of the non-volatile storage device.

10. The computer system of claim 8 wherein said software is configured to clear said non-volatile storage device by writing a character to all addressable locations of said non-volatile storage device.

11. The computer system of claim 8 wherein said software is configured to sanitize said non-volatile storage device by writing a character, the complement of said character, and a random character to all addressable locations of said non-volatile storage device.

12. A computer-implemented method, comprising:
sending a request to remove substantially all of the data contained on a non-volatile storage device by way of a predetermined removal method;
overwriting the data with a program stored in a read-only memory in accordance with the predetermined removal method; and
verifying that the data on the non-volatile storage device is removed according to the predetermined removal method.

13. The method of claim 12 wherein overwriting comprises overwriting the data through basic input output system (BIOS) routines.

14. The method of claim 12 wherein overwriting comprises overwriting the data through extensible firmware interface (EFI) routines.

15. The method of claim 12 wherein overwriting comprises writing a character to all addressable locations of the non-volatile storage device.

16. The method of claim 12 wherein overwriting comprises writing a character, the complement of the character, and a random character to all addressable locations of the non-volatile storage device.

17. A computer readable storage medium on which an executable program is stored that, when accessed by a central processing unit (CPU), causes the CPU to:
erase a non-volatile storage according to a removal method; and
verify the non-volatile storage device has been erased according to the removal method;
wherein the executable program is integrated with boot firmware.

18. The computer readable storage medium of claim 17 wherein the removal method erases the non-volatile storage device by writing a character to all addressable locations of the non-volatile storage device.

19. The computer readable storage medium of claim 17 wherein the removal method erases the non-volatile storage device by writing a character, the complement of the character, and a random character to all addressable locations of the non-volatile storage device.

20. A computer system, comprising:
a non-volatile means for storing data;
a means for initializing components of the computer system; and
a means for overwriting all of the data stored on the non-volatile means for storing data while the means for initializing is controlling the computer system.

21. The computer system of claim 20 wherein the means for overwriting comprises a means for writing a character, a complement of the character, and a random character to the non-volatile means for storing data while the means for initializing is controlling the computer system.
